(19) United States
(12) Patent Application Publication
(10) Pub. No.: US 2012/0131566 A1
(43) Pub. Date: May 24, 2012

(54) EFFICIENT VIRTUAL APPLICATION UPDATE

(75) Inventors: Peter Morgan, Natick, MA (US); Charles Kekeh, Medford, MA (US); Kier Tinker, Medford, MA (US); Kristofer Reierson, Acton, MA (US)

(73) Assignee: MICROSOFT CORPORATION, Redmond, WA (US)

(21) Appl. No.: 12/953,091

(22) Filed: Nov. 23, 2010

(51) Int. Cl. G06F 9/44

(52) U.S. Cl. 717/170

(57) ABSTRACT

Efficient virtual application updating is enabled. An old version of a virtual application can be compared to a new version of the virtual application and updated as a function thereof. A file unchanged from the old version to the new version can be hard linked from the new version to the old version. For a changed file, matching portions of the file can be copied from the old version to the new version, and remaining un-matching portions can be acquired from another source.

### BACKGROUND

Application virtualization is a collection of technologies that enable software applications to be decoupled from an operating system. Rather than being installed directly to a computer in the traditional sense, a virtual application is deployed on the computer as a service. Nevertheless, the virtual application executes as if it were installed on a computer. The application is in some sense fooled into believing it is installed and interfacing directly with a computer operating system. This can be accomplished by encapsulating the application in a virtual environment or virtualization layer that intercepts file and other operations of the application and redirects the operations to a virtualized location.

There are several benefits of application virtualization. In particular, applications are isolated from each other and an executing computer at least to a degree by way of a virtual environment. Accordingly, multiple applications can be run at the same time, including otherwise incompatible or conflicting applications. In addition, applications can be run in environments other than that for which an application was designed. Further, isolation protects other applications and an underlying operating system from poorly written or faulty code.

A virtualization application includes a number of parts. The first part is a package file where application assets, or resources, reside. This package includes data and metadata necessary to run the application on a computer. These resources include but are not limited to files and a directory structure. At runtime, a virtual application comprises these resources, or namespaces, running on the computer. Through virtualization, resource namespaces and native namespaces can be stitched together so that the application can find its resources.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains efficient virtual application updating. A comparison can be made between files of an old version of an application and a new version of the same application. If a new file is unchanged with respect to the corresponding old file, a hard link can be created associating the new file with the old file, rather than producing a duplicate copy. If the file has changed, unchanged portions of the new file can be copied from the old file, and acquisition of changed portions can be initiated from a source such as a server, proxy, client, and/or client data store.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates virtual application update.

FIG. 2 is a block diagram of an exemplary application package.

FIG. 3 is a block diagram of a representative update component.

FIG. 4 is a block diagram of a representative package-build component.

FIG. 5 is a block diagram of a system that facilitates virtual application update.

FIG. 6 is a block diagram of a system that facilitates virtual application update.

FIG. 7 is a flow chart diagram of a method of updating a virtual application.

FIG. 8 is a flow chart diagram of a method of pre-processing to facilitate application update.

FIG. 9 is a flow chart diagram of a method of updating a virtual application.

FIG. 10 is a flow chart diagram of a method of updating a virtual application.

FIG. 11 is a flow chart diagram of a method of acquiring changed data from a source.

FIG. 12 is a schematic block diagram illustrating a suitable operating environment for aspects of the subject disclosure.

### DETAILED DESCRIPTION

Details below are generally directed toward efficient updating (e.g., update/upgrade) of virtual applications. A new version of an application can be created in conjunction with an old version. Various actions can be taken based upon a comparison between the old version and the new version, for example utilizing a block map and central directory. In particular, if a new file remains unchanged with respect to a corresponding old file, a hard link can be created from the new version to the old version of the file. As a result, disk space is preserved since the file need not be duplicated for the new version. Further, interrupted or failed updates do not affect the old version, and the new version can run simultaneously with the old version.

If a file changes, portions of unchanged data (a.k.a. blocks) can be copied from the old version and the remaining portions can be acquired from another source such as a server. Consequently, network bandwidth is conserved since solely changed portions of a file are downloaded. Still further optimizations can be employed to conserved network bandwidth including utilization of a proxy, multiple clients, and multiple client data stores, among other things.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

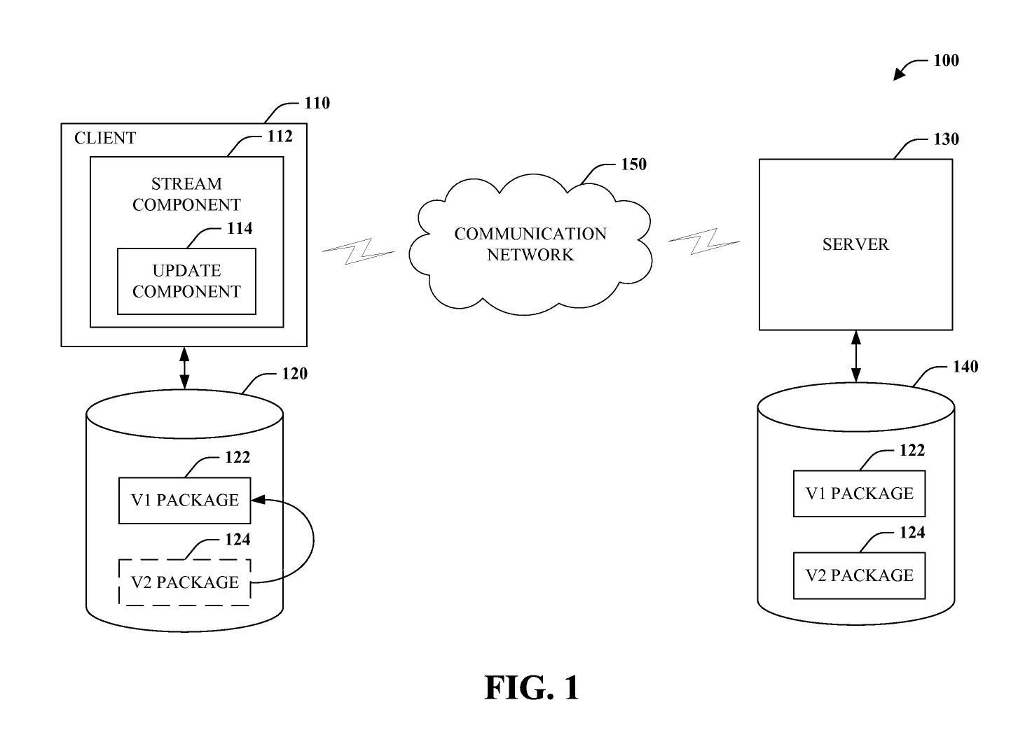

Referring initially to FIG. 1, a system 100 is illustrated that facilitates virtual application updating. The system 100 is configured to operate in accordance with a client-server paradigm. A client 110 and a server 130 can be hardware and/or software (e.g., threads, processes, computers, computing devices). Furthermore, the client 110 can be connected to a client data store 120 and the server can be connected to a server data store 140. Still further, the client 110 and the server 130 can communicate across a communication network including but not limited to a wide-area network such as the Internet.

The system 100 can enable application virtualization, wherein an application is loaded, rather than installed, on the client 110 and associated client data store 120 by streaming the application from the server 130 and server data store 140 across the communications network 150. As shown here, a stream component 112 is configured to effect such streaming of applications by requesting and subsequently receiving the application from the server 130.

For instance, the server data store 140 includes a V1 package 122 that includes executable files and metadata for an application. The stream component 112 can request the V1 package 122 from the server 130. In response, the server 130 can retrieve the V1 package 122 from server data store 140 and transmit the V1 package 122 across the communication network 150 to back to the stream component 112 vis-à-vis the client 110. The stream component 112 can then load V1 package 122 into the client data store 120, which can correspond to local cache. Furthermore, due to the steaming process, portions of the package can be loaded as they are received until the entire package has arrived.

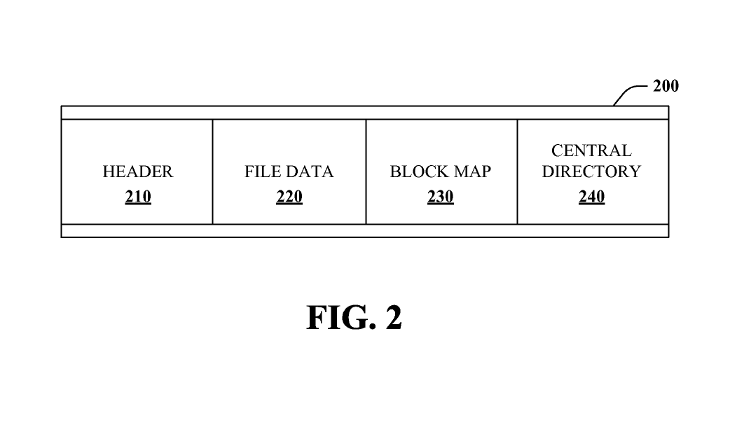

Turning attention briefly to FIG. 2, an exemplary application package 200 is depicted. As illustrated, the application package includes a header 210, file data 220, block map 230, and central directory 240. The header 210 provides general information regarding the application package (e.g., size, offsets . . . ). The file data 220 corresponds to a plurality of executable and non-executable files that implement the functionality of an application. The block map 230 is a metadata file that provides a way for a client to translate from one offset in the local file into an offset into the package. Moreover, the block map 230 provides a block level hash to prevent tampering as well as enable computation of differences between blocks. The central directory 240 includes metadata about files and subdirectories. For example, if an application included a file “foo.exe” and a subdirectory “bar” with files “alpha.dll” and “beta.dll” in “bar,” the central directory 240 would include information necessary to recreate that hierarchy on a local system (e.g., a file called “foo.exe,” a directory “bar” that included two files “alpha.dll” and “beta.dll”).

Returning to FIG. 1, as previously mentioned, the stream component 112 can contact the server 130 and download V1 package 122. More particularly, the central directory can be downloaded and utilized to create a local version of the files and directories in the package. The stream component 112 can then make all files resident on the local system in client data store 120. This can be accomplished by using the block map to go from a location in the local file system (e.g., file “foo.dll,” offset “0×400”) to a range in the package (e.g., “sample.appv,” offset “0×63000”).

The stream component 112 also includes an update component 114 that is configured to update an old version of the application to a new version of the application. Previous update solutions fall into one of two categories, un-install and re-install, and patching. As per un-install and re-install, a previous version of the application including all files is removed from the system and the new version is downloaded and installed. Here, however, if only fifteen percent (15%) of the files in the application changed, all applications files are downloaded. This is an inefficient use of network bandwidth that also increases downtime since the application is not usable during this time. Patching involves computing a patch in a build lab, based on differences between two known versions of the file. The patch is downloaded and then applied on top of the files. This only requires network bandwidth for changed data but it requires that the build lab maintain a library of previous builds to generate differences, and patches need to be applied sequentially (e.g., Patch 1, Patch 2, Patch 3 . . . ).

The update component 114 can provide a more efficient approach to updating virtual applications. More specifically, the update component 114 can conserve storage space by hard linking unchanged files of the new and old versions and make efficient use of a network bandwidth be confining requests to file changes, among other things. Furthermore, both the old version and the new version of an application can coexist and updates need not be implemented sequentially.

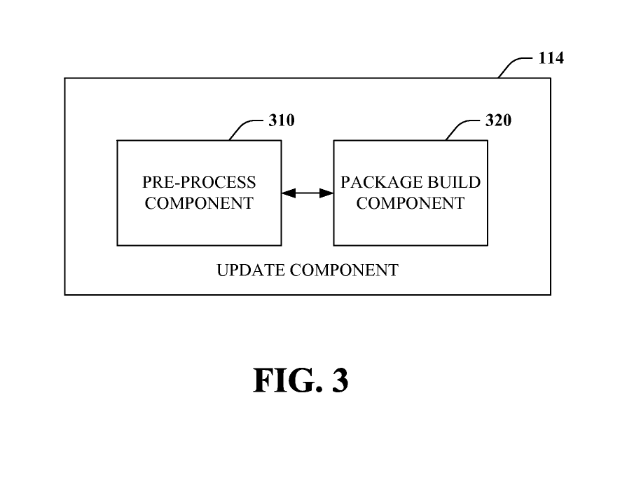

FIG. 3 illustrates a representative update component 114 in further detail. The update component 114 includes a pre-process component 310 and a package build component 320. The pre-process component 310 is configured to perform one or more pre-process actions to facilitate updating an application. By way of example, and not limitation, the pre-process component 310 can create a local sparse copy of a new package utilizing a central directory and block map of an application package, wherein the sparse copy includes sparse files that include metadata (e.g., file name, size . . . ) but are otherwise devoid of content. The package build component 320 can build a local package utilizing the sparse package. For instance, the package build component 320 can link files to other files, copy files, or portions of files, and/or inject new files.

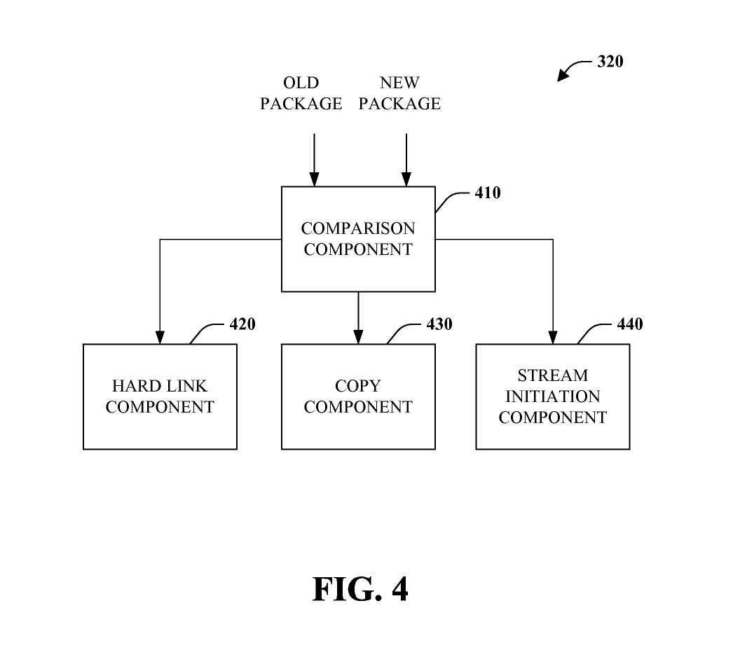

Turning attention to FIG. 4 a representative package-build component 320 is illustrated including a comparison component 410, a hard link component 420, a copy component 430, and a stream initiation component 440. The comparison component 410 can analyze an old package and a new package and identify differences and or similarities between the two. In other words, the comparison component 410 can go through a list of files associated with a first version of an application and a list of files associated with a second version of the application to determine changes. In accordance with one embodiment, results of application of hash function (a.k.a., hash code, hash) on the files or portions of the files can be utilized by the comparison component 410 to identify differences.

If the comparison component 410 determines that a new file is unchanged with respect to an old version of the same file, hard link component 420 can be employed, which is configured to create a hard link between old and new versions of a file. Stated differently, rather than generating the another copy of a file that remains the same, an entry can be inserted in a new version package that associates a file with the identical file made resident by the old package. Such hard linking at least conserves storage space by not storing duplicate copies of a file, but rather using a link to refer to the location of the original file. Although not limited thereto, hard linking can be especially helpful with respect to remote desktop and virtual desktop application deployments where the cost of disk storage is high.

If a file has changed, as determined by the comparison component 410, the copy component 430 and stream initiation component 440 can be utilized. The copy component 430 is configured to copy matching blocks, or, in other words, unchanged portions of the file from the old version to the new version. Hashes provided by the package block map can be utilized to identify matching and non-matching blocks of file. For portions that are changed, the stream initiation component 440 can initiate acquisition of such portions from a source such as a server. Together the copied portions and otherwise acquired portions comprise the file. Furthermore, where the new version includes a new file that is not part of the old version, acquisition of the whole, or entire, new file can be initiated by stream initiation component 440. In this manner, network bandwidth is conserved by confining downloading to portions of changed files and new files that are not part of an old version.

In addition to conserving space and bandwidth, the package build component 320 can allows simultaneous execution of an old version and a new version, as well as failure tolerance during an update. Typical update schemes involve removing or copying over files. Accordingly, if there is an error during an update, the old version can be left in an incomplete state with some files removed or installed (e.g., partial upgrade). By utilizing hard linking and copying portions of files, interrupted or failed upgrades do not to affect the original or old application version. Similarly, the old and new versions of an application can coexist which can be helpful, for example, if there are two users of a particular computer and a first user wants to use a first version of an application and a second user wants to uses a second version of the same application.

Returning to FIG. 1, when a second version of an application becomes available, namely V2 package 124, the update component 114 can initiate a download of the V2 central directory and block map from the server 130. Subsequently, the central directory can be expanded onto the local file system making a sparse file for files and a directory for entries in the content directory. The update component 114 can then go through the list of old and new files, and if a file exists in V2 package 124, the update component 114 will determine whether the file has changed with respect to the V1 package 122. This determination can be made by comparing the hashes of blocks between the old and new file. Files that have not been changed in the updated version can be hard linked by the update component 114, for example from the V1 package location to the V2 package location as illustrated with an arrow. If the file has changed, the update component 114 can copy matching blocks from the old version of the file to the new version of the file and download changed portions. Similarly, if a new file exists in the updated version but not in the original version that file can be downloaded.

In accordance with one embodiment, the block map and central directories of two versions can be utilized to go from one arbitrary version to another. For example, consider a situation where a user has version “1,” but goes offline for a month. During this time, an application vendor issues a number of upgrades or fixes such that the current version is now version “4.” The user need not apply versions “2” and “3” to the package. Rather, the update component 114 can acquire a block map associated with version “4,” compute the differences between version “1” and version “4,” and apply those changes.

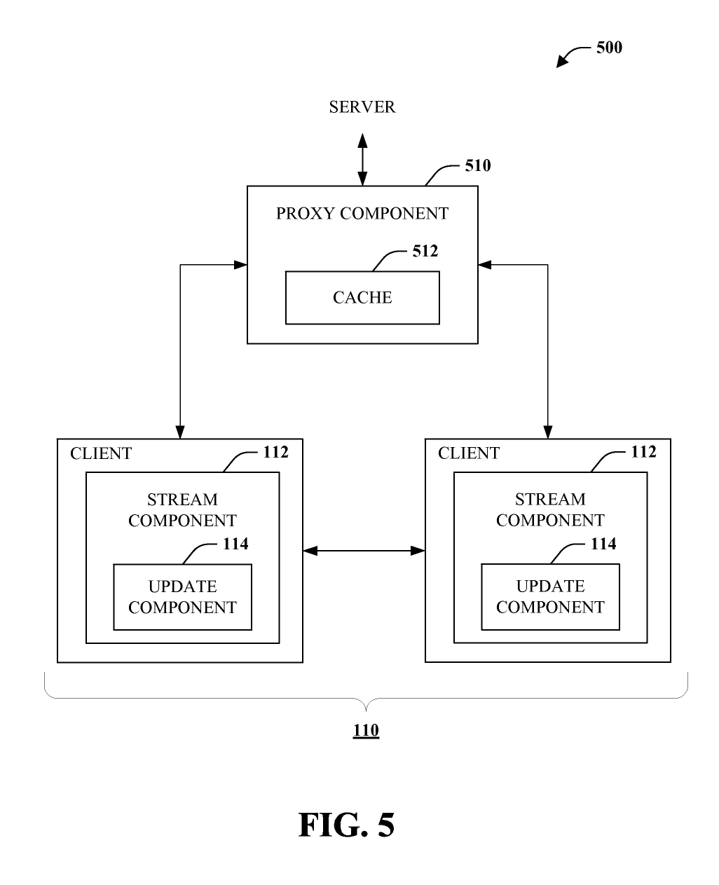

FIG. 5 illustrates a system 500 that facilitates update of a virtual application in accordance with one embodiment. The system 550 can include two or more clients 110 each including the stream component 112 and update component 114. As previously described herein, if files change from an old version of an application to an new version of an application or new files are introduced by the new version, at least a portion such changed data can be acquired from outside a local system. Advantageously, network bandwidth can be conserved by confining downloads to changes. However, data acquisition can be further optimized utilizing a proxy component 510.

The proxy component 510 is a local or remote proxy or intermediary with a cache 512 for storing files or portions thereof, among other things. Multiple clients 110 can interact with the proxy component 510 to obtain changed data. If the requested data was previously retrieved from a server and resident in the cache 512, the data can be returned to a requesting client. Alternatively, the data can be retrieved from a server and stored in the cache 512 for subsequent use. In this manner, an updated application package can be downloaded once by the proxy component 510 and utilized by a plurality of clients 110 as opposed to being downloaded separately by each client.

Furthermore, where a client 110 is communicatively coupled to another client 110, upgrade information can be exchanged. For instance, if on a first client it is determined that a file needs to be acquired, the first client can request the file from a second client, which can return a copy of the file. As a result, network bandwidth can be further conserved by way of client-to-client communication (e.g., wired, wireless, Bluetooth . . . ). As well, updates can be performed even if the server is unavailable.

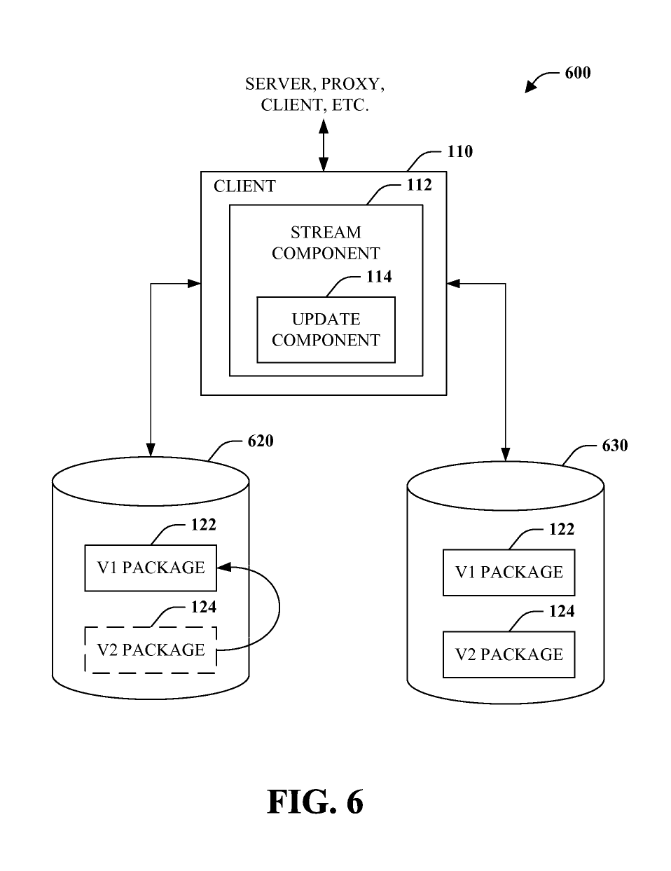

FIG. 6 illustrates system 600 that facilitates update of virtual applications in accordance with one embodiment. The system includes the client 110, stream component 112, and update component 114, as previously described. In addition, the client 110 includes and/or interacts with two client data stores, first client data store 620 and second client data store 630. In some scenarios, a client 110 can support multiple but separate users such that each user has a particular client data store. The update component 114 can utilize these separate stores to acquire changed data, among other things. For example, if the V1 package 122 is to be updated to the V2 package 124 with respect to first client data store 620, the second client data store 630 can be queried and utilized, where able, to acquire changed data or new files not included with respect to the old version V1 package 122. Of course, if another client data store is not available or does not have needed data then the update component 114 can seek to acquire the data from a server, proxy, or other client, among other sources.

As described above, the update component 114 can acquire data from various sources such as a server, a proxy, a client, or a client data store. Of course, this list of sources is not exhaustive. Furthermore, the update component 114 need not utilize one source to the exclusion of others. In fact, multiple sources can be utilized to acquire data with respect to the same or different files. In addition, data can be requested from the two or more sources simultaneously, where the data is used from the first source to respond to a request. Additionally, decisions can be made as to which one or more sources should be used based any number of factors including but not limited to available sources, predicted response time, financial cost, and load.

Still further yet, the update component 114 can not only make decisions about what source(s) to request data from but also the amount of data requested. In accordance with one embodiment, the update component 114 can confine requests to changed data and new files that did not form part of a previous version. However, the update component 114 can be configured to retrieve more data. For example, a threshold can be pre-established, determined, or inferred with respect a change amount. If, for instance, a file includes changes that affect more than fifty percent (50%) of the file, then the entire file can be requested rather that only the changed portions. The threshold can be throttled based on a number of factors including client and network load as well as network speed and cost, among other things. By way of example, if a there is a per data unit (e.g., kilobyte, megabyte . . . ) financial cost associated with network usage then the threshold can be set to a high value indicating that the percentage change of a file would need to be close, if not equal, to one hundred percent (100%) before a request is made for an entire file.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the update component 114 can utilize such mechanisms to determine or infer an amount of data to retrieve and from which one or more sources data will be requested.

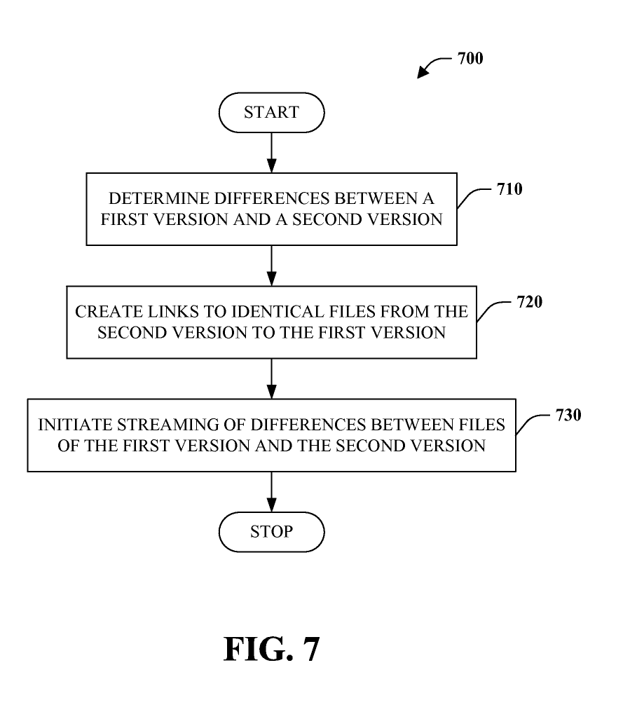

In view of the exemplary systems described supra, methodologies that may be implemented in accordance with the disclosed subject matter will be better appreciated with reference to the flow charts of FIGS. 7-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a method 700 of updating a virtual application is depicted. At reference number 710, differences between a first version of an application and a second version of an application are determined. For example, hash code associated with file blocks can be utilized to determine whether a portion of the file, and thus the file itself, is different. At numeral 720, hard links can be created to identical files from the first and second version. In other words, files that are unchanged from the first to the second version are linked to the location of the file for the first version rather than making a duplicate copy for the second version. At reference numeral 730, streaming, or downloading, of differences between files of the first version and the second can be initiated with respect to one or more sources including, without limitation, a server, a proxy, a client, and/or a client data store.

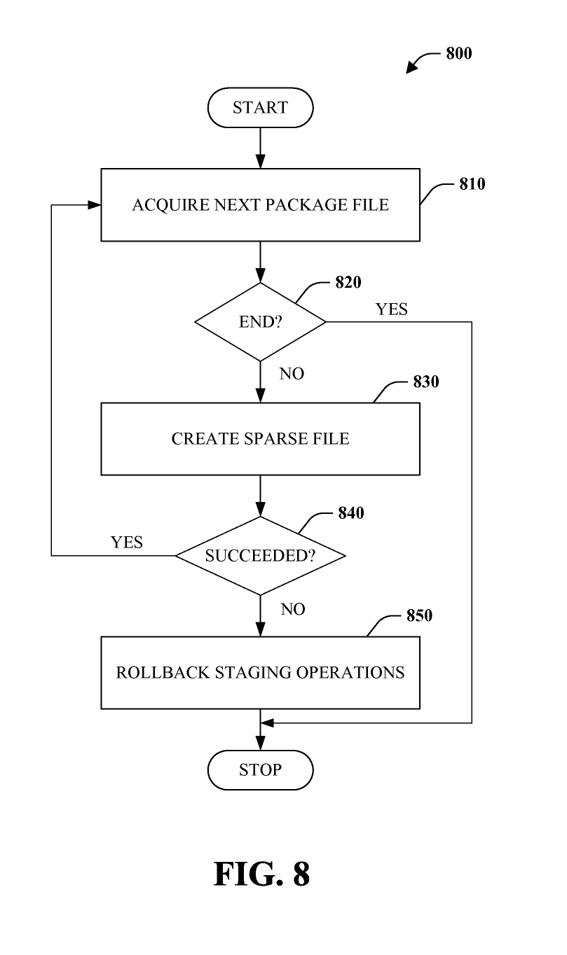

FIG. 8 is a flow chart diagram of a method 800 of pre-processing to facilitate application update. At reference numeral 810, the next package file is acquired. At numeral 820, a determination is made as to whether all the files of a package have been processed, or in other words, whether the end of a list of files has been reached. If the end has been reached (“YES”) indicating that all package files have been processed, the method 800 terminates. If, however, the end has not been reached (“NO”), a sparse file is created for the particular file including metadata (e.g., file name, size . . . ) but otherwise devoid of content. A check is then made as to whether creation of the sparse file succeeded at 840. If creation succeeded (“YES”), the method 800 loops back to reference numeral 810 where the next package file is acquired. If creation was unsuccessful (“NO”), the method 800 proceeds to 850 where previously performed pre-processing, or staging, operations are rolled back (e.g., undone) and the method 800 terminates.

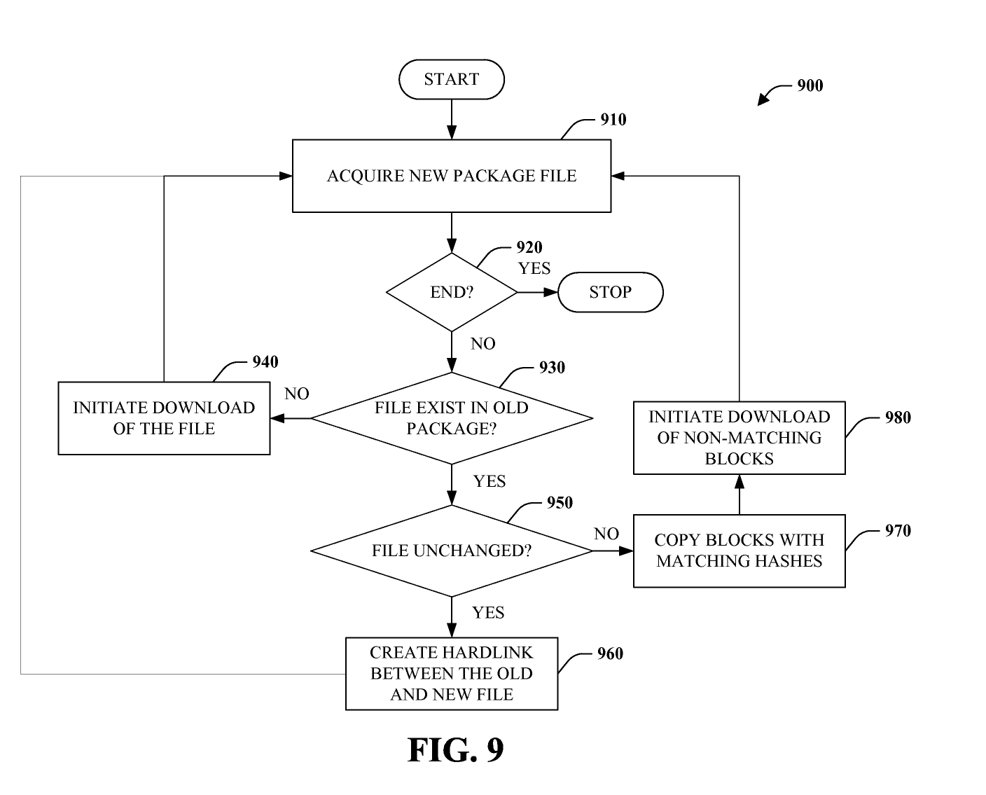

FIG. 9 illustrates a method 900 of updating a virtual application. At reference numeral 910, a file is acquired from or otherwise identified with respect to a new package. At numeral 920, a decision is made as to whether all the files in the package have been processed, or in other words, whether the end of a list of files has been reached. If all files have been processed (“YES”), the method 900 terminates. Alternatively (“NO”), the method 900 continues at 930 where a determination is made as to whether the file exists in the old package. If it does not exist in the old package (“NO”), the method 900 continues at 940 where downloading of the file is initiated or queued, and the method 900 loops back to reference numeral 910. If the file does exist in the old package (“YES)”, the method 900 continues, at 950, where a decision is made as to whether the new file is unchanged with respect to a corresponding old file, for example by comparing hash codes associated with the files or portions of the files. If the file is unchanged (“YES”), the method 900 proceeds to 960 where a hard link is created between the old and new file such that the new file is associated with the location of the resident old file. Subsequently, a new package file can be acquired at reference numeral 910. If, however, at 950, it is determined that the file has changed (“NO”), then the method 900 continues at numeral 970 where blocks with matching hash codes are copied from the file and added to the new file. Stated differently, portions of data that are unchanged from the old file to the new file are copied from the old file and added to the new file. At reference numeral 980, downloading of non-matching blocks of the file is initiated. Subsequently, the copied data and the acquired data can be combined to form the new file. Next, the method 900 returns to reference numeral 910 to acquire the next file until all files have been processed.

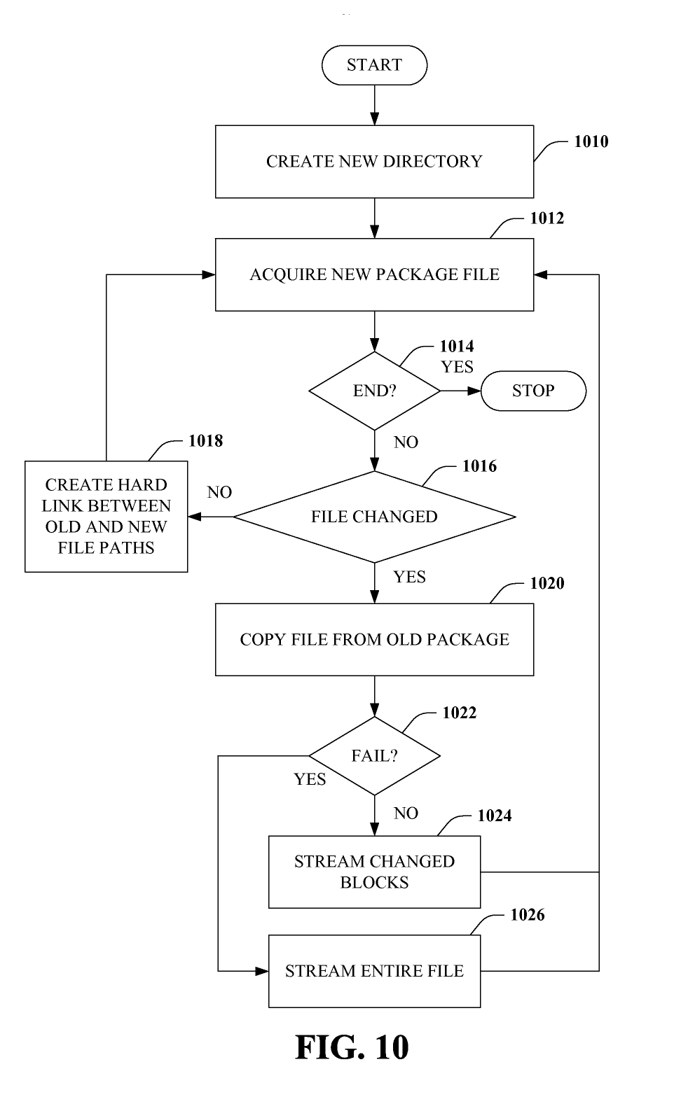

FIG. 10 depicts a method 1000 of updating a virtual application. At reference numeral 1010, a new directory is created. The new directory can be a sparse directory and include one or more sparse files comprising information about the file but devoid of file content. At numeral 1012, a new package file is acquired from, or otherwise identified by, the sparse directory. A check is made at 1014 as to whether all files in the package have been processed, or in other words, whether the end of the package or list of files has been reached. If all package files have been processed (“YES”), the method 1000 terminates. Alternatively (“YES”), the method continues at numeral 1016 where a determination is made as to whether the new file has changed with respect to an old or previous version of the file. If the file has not changed (“NO”), the method continues at 1018 where a hard link is created between old and new file paths, and subsequently a new file is acquired, or identified, at numeral 1012. If the file has changed (“YES”), the method 1000 proceeds to 1020, where an attempt is made to copy at least portions of the file from a corresponding old file of the old package (e.g., unchanged). If it is determined at numeral 1022 that the copy act of 1020 succeeded, or in other words did not fail (“NO”), the method continues at 1024 where changed block streaming, or downloading, is initiated. Subsequently, the method 1000 returns to numeral 1012 where the next file is acquired. However, if, at 1022, it is determined that the copy act of 1020 failed (“YES”), the method 1000 proceeds to 1026 where streaming of the entire file is initiated, and loops back to numeral 1012 to acquire, or identify, the next file.

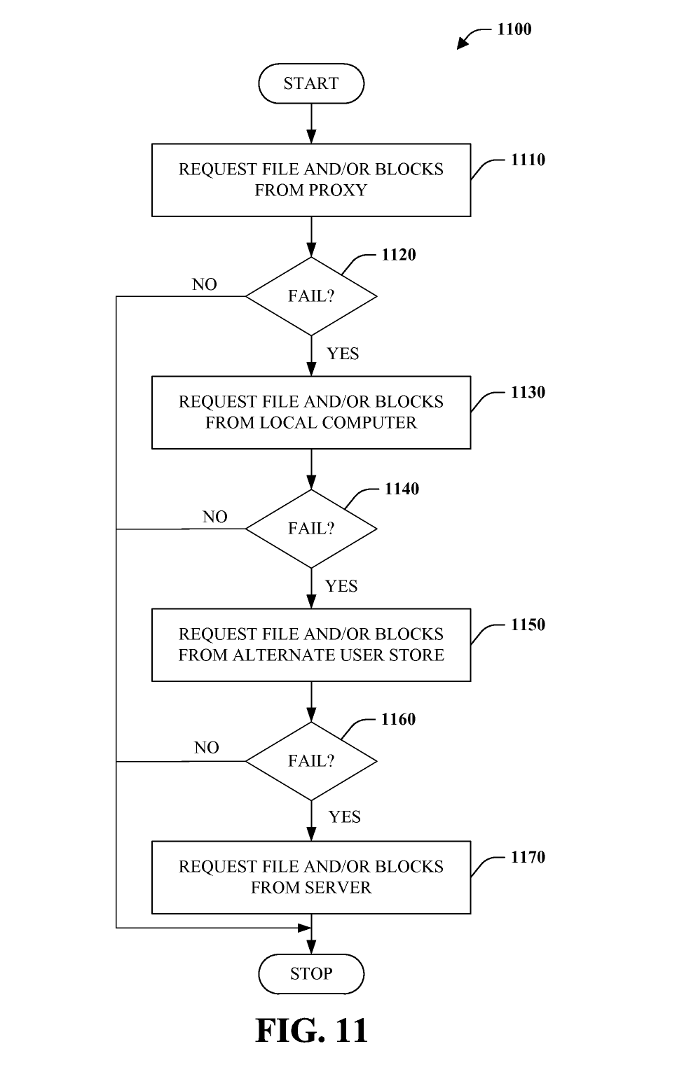

FIG. 11 is a flow chart diagram of a method 1100 of acquiring changed data from a source. At reference numeral 1110, an entire file and/or file blocks are requested from a proxy. A determination as to whether that request failed, or stated differently was not fruitful, is made at 1120. If the request returned requested results (“NO”), the method 1100 terminates. Alternatively, if the request fails (“YES”), the method 1100 continues at numeral 1030, where the entire file and/or file blocks are requested from a local computer. In other words, a wired or wireless request for changed data can be made with respect to another local computer. If at 1140, the request returns results, the method 1100 terminates. Alternative (“YES”), the method 1100 proceed to 1150 where a request for the entire file and/or blocks is made to an alternative user store on a single machine. If the request succeeds, or in other words does not fail (“NO”), the method 1100 terminates. If the request fails to yield requested data (“YES”), the method 1100 continues at reference numeral 1170, where the entire file and/or file blocks are requested from a server such as a virtual application server and the method 1100 terminates. In sum, an entire file and/or file blocks can be requested from one of many other data source besides the application server, and if the many other data sources can provide the requested data then wide area network bandwidth can be conserved.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

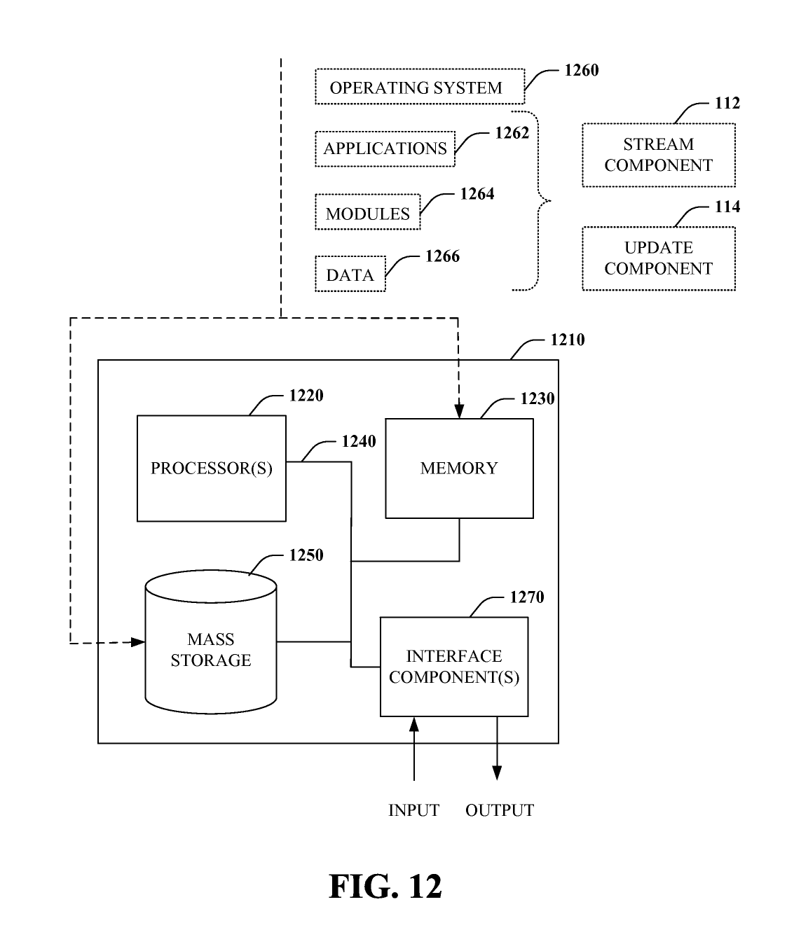

In order to provide a context for the claimed subject matter, FIG. 12 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 12, illustrated is an example general-purpose computer 1210 or computing device (e.g., desktop, laptop, server, hand-held, programmable consumer or industrial electronics, set-top box, game system . . . ). The computer 1210 includes one or more processor(s) 1220, memory 1230, system bus 1240, mass storage 1250, and one or more interface components 1270. The system bus 1240 communicatively couples at least the above system components. However, it is to be appreciated that in its simplest form the computer 1210 can include one or more processors 1220 coupled to memory 1230 that execute various computer executable actions, instructions, and or components stored in memory 1230.

The processor(s) 1220 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1220 may also be implemented as a combination of computing devices, for example a combination of a DSP and a microprocessor, a plurality of microprocessors, multi-core processors, one or more microprocessors in conjunction with a DSP core, or any other such configuration.

The computer 1210 can include or otherwise interact with a variety of computer-readable media to facilitate control of the computer 1210 to implement one or more aspects of the claimed subject matter. The computer-readable media can be any available media that can be accessed by the computer 1210 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1210.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1230 and mass storage 1250 are examples of computer-readable storage media. Depending on the exact configuration and type of computing device, memory 1230 may be volatile (e.g., RAM), non-volatile (e.g., ROM, flash memory . . . ) or some combination of the two. By way of example, the basic input/output system (BIOS), including basic routines to transfer information between elements within the computer 1210, such as during start-up, can be stored in nonvolatile memory, while volatile memory can act as external cache memory to facilitate processing by the processor(s) 1220, among other things.

Mass storage 1250 includes removable/non-removable, volatile/non-volatile computer storage media for storage of large amounts of data relative to the memory 1230. For example, mass storage 1250 includes, but is not limited to, one or more devices such as a magnetic or optical disk drive, floppy disk drive, flash memory, solid-state drive, or memory stick.

Memory 1230 and mass storage 1250 can include, or have stored therein, operating system 1260, one or more applications 1262, one or more program modules 1264, and data 1266. The operating system 1260 acts to control and allocate resources of the computer 1210. Applications 1262 include one or both of system and application software and can exploit management of resources by the operating system 1260 through program modules 1264 and data 1266 stored in memory 1230 and/or mass storage 1250 to perform one or more actions. Accordingly, applications 1262 can turn a general-purpose computer 1210 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the stream component 112 and updated component 114, or portions thereof, can be, or form part, of an application 1262, and include one or more modules 1264 and data 1266 stored in memory and/or mass storage 1250 whose functionality can be realized when executed by one or more processor(s) 1220.

In accordance with one particular embodiment, the processor(s) 1220 can correspond to a system on a chip (SOC) or like architecture including, or in other words integrating, both hardware and software on a single integrated circuit substrate. Here, the processor(s) 1220 can include one or more processors as well as memory at least similar to processor(s) 1220 and memory 1230, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the stream component 112, the update component 114, and/or associated functionality can be embedded within hardware in a SOC architecture.

The computer 1210 also includes one or more interface components 1270 that are communicatively coupled to the system bus 1240 and facilitate interaction with the computer 1210. By way of example, the interface component 1270 can be a port (e.g., serial, parallel, PCMCIA, USB, FireWire . . . ) or an interface card (e.g., sound, video . . . ) or the like. In one example implementation, the interface component 1270 can be embodied as a user input/output interface to enable a user to enter commands and information into the computer 1210 through one or more input devices (e.g., pointing device such as a mouse, trackball, stylus, touch pad, keyboard, microphone, joystick, game pad, satellite dish, scanner, camera, other computer . . . ). In another example implementation, the interface component 1270 can be embodied as an output peripheral interface to supply output to displays (e.g., CRT, LCD, plasma . . . ), speakers, printers, and/or other computers, among other things. Still further yet, the interface component 1270 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of updating virtual applications, comprising:
employing at least one processor configured to execute computer-executable instructions stored in memory to perform the following acts:
comparing a loaded first version of a virtual application with metadata of a second version of the virtual application; and
creating a hard link to a file of the first version where the file is unchanged from the first version to the second version.

2. The method of claim 1 further comprises initiating acquisition of at least a portion of the file if changed from the first version to the second version.

3. The method of claim 2, initiating access of the at least a portion of the file from a server.

4. The method of claim 2, initiating acquisition of the at least a portion of the file from a proxy.

5. The method of claim 2, initiating acquisition of the at least a portion of the file from a local computer.

6. The method of claim 1 further comprises initiating acquisition of the file as a whole if the file is not part of the first version.

7. The method of claim 1 further comprises copying a portion of the file from the first version.

8. The method of claim 1 further comprises initiating acquisition of the file as a whole from a source where the file is different with respect to the first version and the second version.

9. The method of claim 8, initiating acquisition of the file when an amount of change meets or exceeds a threshold.

10. A system that facilitates update of a virtual application, comprising:
a processor coupled to a memory, the processor configured to execute the following computer-executable components stored in the memory:
a first component configured to compare a loaded, old version of an application package with a new version of the application package;
a second component configured to create hard link between the new version and the old version of an unchanged file; and
a third component configured to initiate acquisition of at least a portion of a changed file from a source.

11. The system of claim 10 further comprises a fourth component configured to copy a portion of the changed file from a corresponding file from the old version of the application package.

12. The system of claim 10, the third component is configured to initiate acquisition of a new file, unique to the new version, from the source.

13. The system of claim 10, the third component is configured to initiate acquisition of an entire changed file from the source based on change extent.

14. The system of claim 10, the source is a remote server.

15. The system of claim 10, the source is a proxy.

16. The system of claim 10, the source is local computer.

17. The system of claim 10 further comprising a fourth component configured to build a sparse copy of the new version of the application package.

18. A computer-readable storage medium having instructions stored thereon that enables at least one processor to perform the following acts:
comparing a first version of a loaded virtual application with a second version of the virtual application;
creating a hard link to a first file of the first version from the second version that is unchanged from the first to the second version;
copying at a portion of a second file from the first version to the second version if the second file differs from the first to the second versions; and
initiating acquisition of remaining portions of the second file from an external source.

19. The computer-readable storage medium of claim 18 further comprises initiating acquisition of a third file that is not included in the first version.

20. The computer-readable storage medium of claim 18, further comprising initiating acquisition of the remaining portions from a proxy.
